(19) United States
(12) Patent Application Publication
(10) Pub. No.: US 2003/0107559 A1
(43) Pub. Date: Jun. 12, 2003

(54) Control of a liquid crystal display

(76) Inventor: Geoffrey Giles Furman, Rush, NY (US)

Correspondence Address: Stephen B. Salai, Esq., Harter, Secrest & Emery LLP, 1600 Bausch & Lomb Place, Rochester, NY, 14604-2711, US

(21) Appl. No.: 10/020,444

(22) Filed: Dec. 11, 2001

(51) Int. Cl. G09G 5/00

(52) U.S. Cl. 345/204

(57) ABSTRACT

A method of controlling a color field sequential display, using a standard progressive scan display controller and an interrupt to control the sequence of colors. A pixel memory is scanned to provide successive primary color images which together make up a multicolored image frame. The interrupt is used to initiate the transition between consecutive scans between the different primary color images.

### FIELD OF THE DISCLOSURE

A method of controlling a display, and in particular a method of using a progressive scan LCD controller to drive a color field sequential display.

### BACKGROUND OF THE DISCLOSURE

Portable computers, PDAs, cellular phones, and communications products have a need for a visual display having at least the resolution provided by a 640×480-pixel array. A 640×480-pixel display is commonly referred to as a VGA display.

The displays in such devices today typically utilize low-resolution, direct view, display panels that are typically 5×8 cm in area. These displays are a compromise from VGA because of their small size and because they are a direct view solution. The lower limit of resolution compatible with the capability of a human eye in a direct view system is 320×240 (quarter VGA). With the current state of the art, other solutions that might otherwise be considered involve excessive cost or excessive weight or both.

A solution to this problem is to utilize a very small format high-resolution display with a lens system to create a virtual display. With this solution a user views a large virtual image, in a package smaller than a 1-inch cube. To keep the cost down in the manufacture of these small displays a designer builds a 640×480 pixel display that is capable of supporting a screen refresh rate of at least 3 times the normal 60 hz rate. With this the electronics designer must supply a color field sequential video pattern that cycles in some selected order through red, green and blue images.

Most portable electronic devices in the market today are based around a CPU (central processing unit). In the interest of lowering cost these CPUs are very highly integrated to consolidate many of the discrete electronics requirements into a single piece of silicon. This consolidation often includes a display controller that is designed to work with the direct view flat panel displays in a progressive scan (PS) fashion.

To work with the small format displays a color field sequential (CFS) display is preferred to the PS display, for reasons which will become apparent. However, it has hitherto been necessary to provide a frame buffer to reformat progressive scan image data into a field sequential mode. This separate buffer (and associated electronics) takes up board space, consumes power and adds cost, all undesirable attributes.

Therefore, there is a need for a low cost, low power, lightweight system for controlling a high resolution graphical display in portable electronics devices.

As is known in the art, an LCD has an array of pixels, each of which responds to an input corresponding to each of three primary colors, red, green and blue. There are two common types of color LCD. One is a progressive scan (PS) display, in which each pixel comprises three sub-pixels, each sub-pixel corresponding to a different primary color, all three responding simultaneously to a corresponding input signal and providing three spatially separated stimuli to a viewer's eye. The other type is a color field sequential (CFS) display, in which each pixel receives inputs for all three primary color inputs; however, in this case the signals are separated temporally and the pixel responds with an output corresponding to the particular primary color input. The way in which the pixels of a CFS display separately produce different primary color outputs is known in the art.

Both types of display are driven by a controller, which scans a pixel memory to provide input signals to each pixel. Because of the difference between the PS and CFS display, data in the pixel memory have hitherto been structured differently according to which type of display is used, or a frame buffer has been used with the CFS display, as indicated earlier.

The pixel memory for the CFS display is the more complex. Furthermore, the LCD controller is configured differently according to whether progressive or CFS scanning is required.

Because the PS display physically requires sub pixels, in effect it has three times the number of pixel units as the CFS display. This added complexity renders it more expensive to manufacture and less compatible with use in compact devices such as handheld computers.

While the CFS display is on the face of it better suited for small format applications, much of the benefit associated with its lower cost and potential compactness is lost because of the added complexity of the corresponding pixel memory.

A frame buffer between the controller and the display can reformat progressive scan image data, after scanning, into a field sequential mode. This has the disadvantages mentioned earlier regarding increased size, power consumption and cost.

There is therefore a need for a means of controlling a CFS display which will overcome these disadvantages. That is, there is a need for a means to control a small format CFS display which is both compact and economical in power consumption.

### SUMMARY OF THE INVENTION

The present disclosure is directed towards the control of a liquid crystal display (LCD), and in particular to a display for images in color. Any reference to an LCD will be understood to refer to a color display.

The disclosure reveals a method for controlling a display utilizing a progressive scan LCD controller in a fashion that will directly drive a color field sequential display. The controller may be integrated into a central processing unit (CPU) or it may be independent. To further the power reduction requirements, this application also discloses an alternative digital/analog (d/a) converter design that is compatible with the digital output from the LCD controller that also significantly reduces the power and size requirements from standard video d/a converters.

The invention comprises using a CPU and an LCD controller, the controller being intended to provide a progressive scan signal to drive a color field sequential display. At the heart of the invention is the use of an interrupt feature, which is a timing device conventionally used to provide a discrete interval between scans. The interrupt feature provides for actuating device-control functions between scans that might, if performed during an actual scan, interfere with the scanning process.

This allows one to combine the PS-configured LCD controller and a CFS display in devices, while avoiding the need for an energy-consuming frame-buffer. The interrupt feature directs the scanning of the PS-configured pixel memory so that a multicolored image on the display is built up by providing image frames one primary color at a time, as opposed to providing complete spectral input data pixel by pixel.

### BRIEF DESCRIPTION OF THE DRAWINGS

FIG. 1 shows a color display having an array of pixels.

FIG. 1 a shows an enlarged view of one of the pixels in a progressive scan display.

FIG. 1b shows an enlarged view of one of the pixels in a color field sequential display.

FIG. 2 is a block diagram showing a system whereby the progressive scan display receives input from a pixel memory appropriately configured therefor.

FIG. 3 is a block diagram showing a system whereby the color field sequential display receives input from a pixel memory appropriately configured therefor.

FIG. 4 is a block diagram showing a system whereby the color field sequential display receives input from an pixel memory configured for a progressive scan display, the system including a frame buffer.

FIG. 5 is a block diagram showing a system of the present invention whereby the color field sequential display receives input from a pixel memory configured for a progressive scan display, the system not including a frame buffer.

FIG. 6 is a schematic of a scanning sequence in the system of FIG. 5 including an interrupt.

FIG. 7 shows the formation of an image from sequentially formed primary color images.

### DETAILED DESCRIPTION OF THE INVENTION

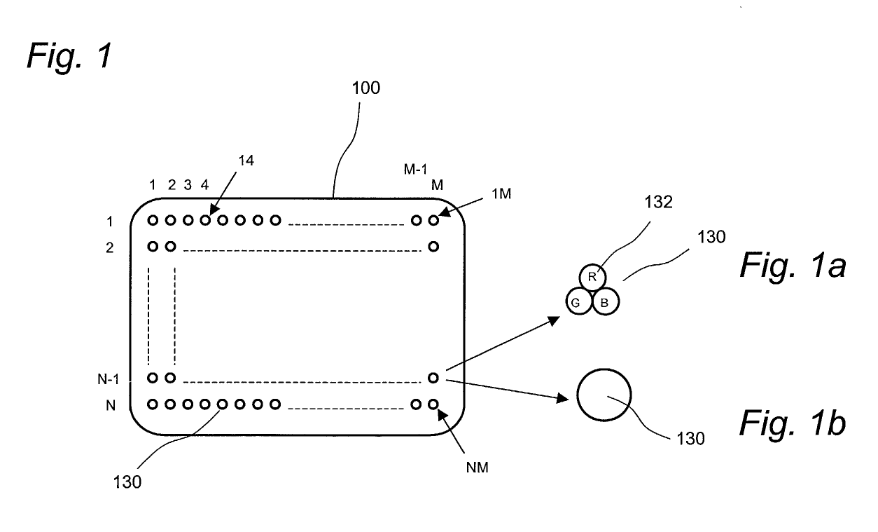

A color liquid crystal display (LCD) 100 as indicated in FIG. 1 has a plurality of pixels 130 typically arranged in an array having M columns and N rows. In a commonly used display, M=640 and N=480. For the purposes of this description, each pixel has a 2-digit identifier based on the horizontal and vertical coordinates, the first digit representing the row and the second digit representing the column. For example, 12 refers to the first row, second pixel.

The pixels 130 can be actuated on receiving input signal 154 from a pixel memory 150. An image 136 on the display 100 is made up of brightness and color contributions from all the individual pixels 130. Consecutive frames 134 are produced at intervals typically of 1/60 second, i.e., at a frequency of 60 Hz. At such high frequencies, the frames 134 appear to a human eye to merge into one continuous image 136. Successive frames 134 may be identical, providing a stationary image, or they may differ, providing a changing or moving image. The pixel memory is scanned by an LCD controller 140, itself controlled by a CPU 142. The CPU 142 can for example be a microprocessor. Since conventional displays require an analog signal, the signal provided by the controller 140 is transmitted to the display 100 through a d/a converter 144.

Individual LCD pixels are commonly configured in one of two ways. In a progressive scan (PS) display, each pixel is a combined pixel made up of individual monochromatic sub-pixels 132, each sub pixel responding to one of three primary colors red, green and blue (R, G, B). The sub-pixels are typically disposed at the corners of an equilateral triangle to build up the combined pixel, as shown in FIG. 1a. Within a pixel 130, all the sub pixels 132 are actuated simultaneously, since all the RGB input data arrive simultaneously. In a color field sequential (CFS) display, each pixel is integral, as shown in FIG. 1b. That is, there are no sub-pixels. The pixel is actuated by each of the primary color input signals 154 in sequence.

Considering an entire frame, then, the frame of the PS display is built up by providing in turn to each (combined) pixel all the required spectral input. By contrast, the frame of the CFS display is built up by providing in turn to each pixel the input for one primary color, then repeating for the other primary colors in turn.

The human eye responds in the same way to both modes of activating the pixels. In other words, given sufficient spatial or temporal proximity of visual stimuli, the eye combines three given particular primary color stimuli in the same way and sees the same resultant color.

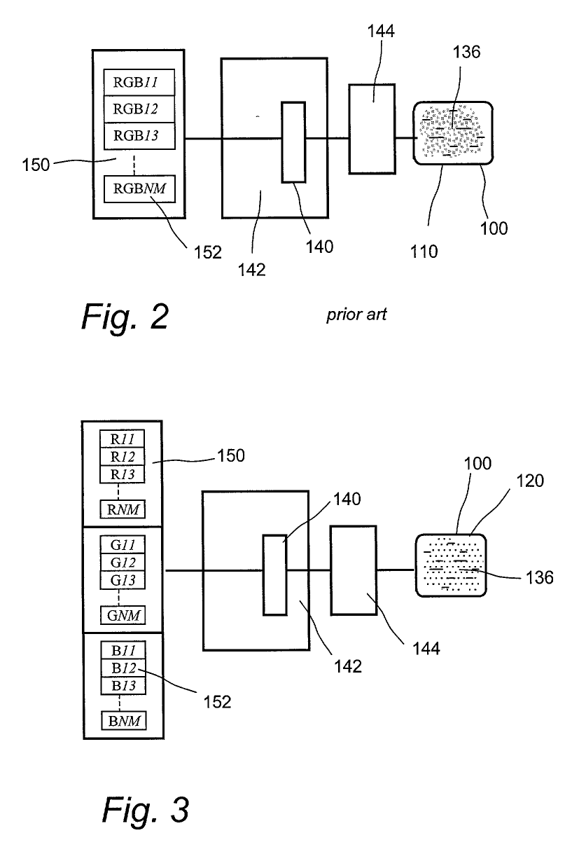

Referring to FIGS. 2 and 3, the pixel memory 150 has typically been differently structured or organized depending on whether the PS display 110 or CFS display 120 is used. The pixel memory 150 can be considered as being made up of memory locations 152, each one of which contains input data directed to a single pixel 130.

For the PS display 110, each memory location 152 contains all the spectral input data for the corresponding pixel 130, and when scanned by the LCD controller 140, provides the input data simultaneously to all three sub-pixels 132. This is shown schematically in FIG. 2. There are as many memory locations 152 as there are pixels. To provide a given frame, the memory locations of the first row are scanned in turn in the order RGB11, RGB12 . . . . . RGB1M. The RGB prefix indicates that when a given memory location is scanned, complete spectral input is provided to the corresponding pixel 130. Scanning continues to actuate the pixels in succeeding rows, up to RGBNM. This completes one frame.

The pixels 130 of the CFS display 120 are integral, that is, they do not include sub-pixels. They are configured to be able to respond to all three primary color inputs. However, they only respond to one primary color input at a time; instead, the primary color inputs are separated temporally. To achieve this, each individual memory location 152 contains input data for only one primary color. The memory locations 152 are organized so that when scanned, they provide in order all the inputs for one primary color, then repeat the process for the other primary colors in turn. Thus there are three memory locations 152 for each pixel 130, one for each primary color. The memory locations of the first row are scanned in turn for a first primary color, say red, in the order R11, R12 . . . R1M. The R prefix indicates that when a given memory location is scanned, only red input is provided to the corresponding pixel. Scanning continues to actuate the pixels in succeeding rows, up to RNM. This completes the red image for one frame. Such a sequence is repeated for the other primary colors in an order such as G11, G12 . . . G1M . . . GNM, then B11, B12 . . . B1M . . . BNM, the actual order of the primary color inputs being immaterial. Thus, images of the three primary colors are formed in succession to complete a frame, at which point they are perceived as a complete spectral image 136. FIG. 3 schematically shows how the system for controlling the CFS display is configured.

Various clocks are incorporated into the CPU for controlling the scans for both types of display. The interval between scanning one memory location and its immediate successor is determined by pixel clock. A horizontal clock determines the point at which scanning indexes from one row to the next row, and a vertical clock determines the time taken to scan an entire frame. The horizontal and vertical clocks may be reset independently to allow for controlling displays with different numbers of columns and rows.

As indicated above, the particular type of display—PS or CFS—is typically associated with a pixel memory 150 having a corresponding configuration.

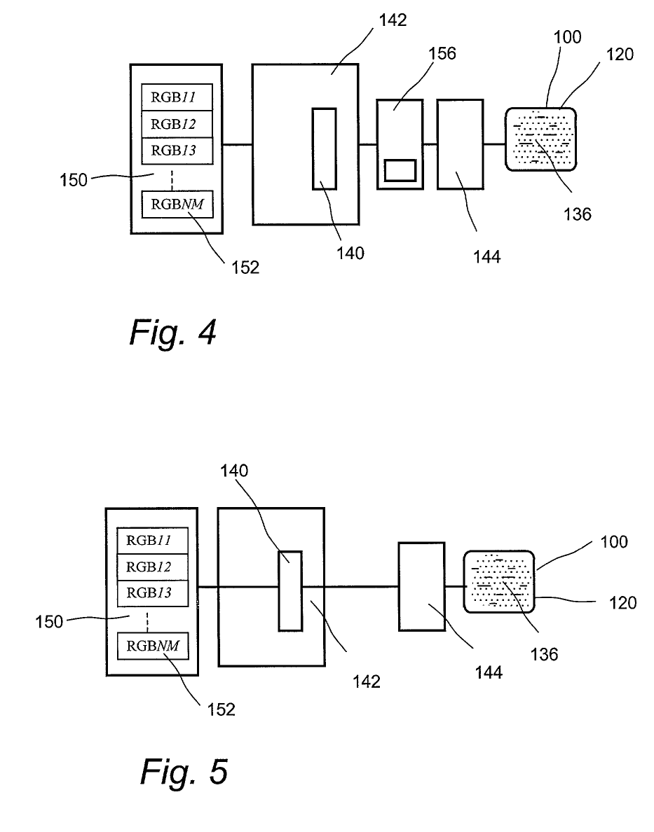

The CFS display 120 is better suited to compact devices, since the same pixel can be actuated by the each of the primary color inputs. The need for subpixels is eliminated and the physical number of pixel units is reduced by a factor of three. This allows the provision of a simpler, less expensive and more compact display. However, this advantage has hitherto been offset by the added complexity of the corresponding pixel memory. Alternatively, it is possible to use the CFS display with the PS configured memory, as in FIG. 4, but this requires a frame buffer 156 to reformat progressive scan image data into a sequential mode, the electronics for which take up space and require significant energy.

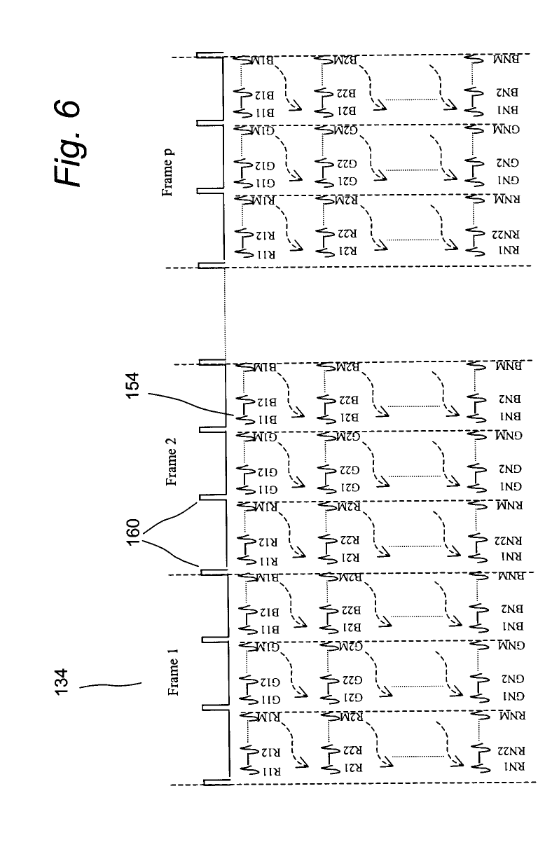

The present invention, whereby the CFS display 120 draws on a pixel memory configured for a PS display without need for the frame buffer 156 is shown as a block diagram in FIG. 5 and also schematically in FIG. 6.

Each PS memory location 152 containing input data for all three primary colors, the CPU 142 sorts and reorganizes the pixel memory according to primary color but in proper sequence for scanning. Alternatively, the CPU 142 is programmed to scan the original memory for only one primary color at a time, until all contributions of that color for a given image frame have been scanned.

In either case, the image 136 is produced by sequentially forming images 138 corresponding to each of the three primary colors. Each primary color image 138 is formed by actuating pixels in the sequence 11, 12, 13 . . . 1M, the interval between pixels being determined by a pixel clock. After pixel 1M, the horizontal clock indexes scanning to the second row in the sequence 21, 22, 23 . . . 2M. The process continues in this way through row N and pixel NM, at which point the vertical clock signals completion of the current primary color image 138. The horizontal and vertical clocks can be selectably adjusted to provide for displays with different pixel array, i.e., with different values of M and N.

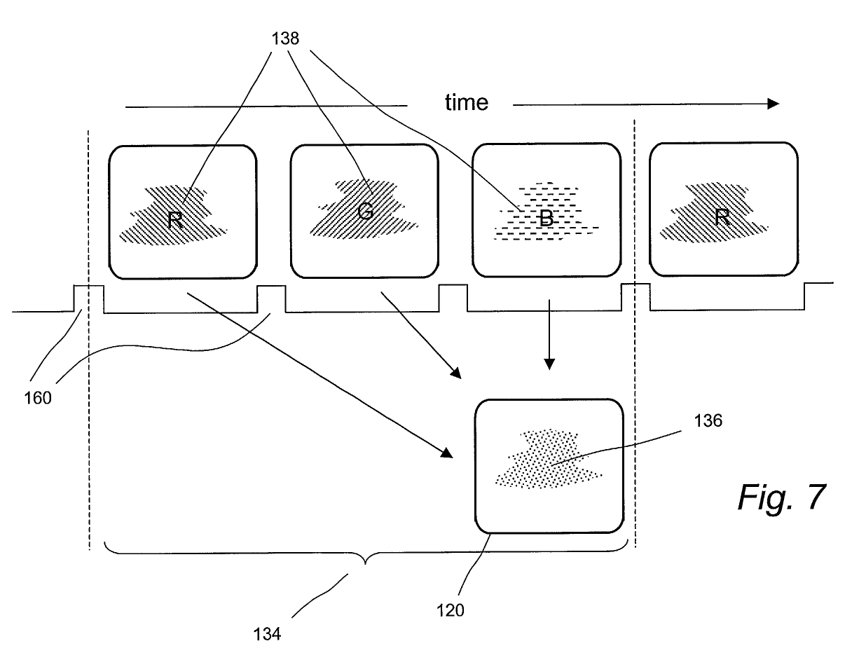

According to the present invention, an interrupt 160 is used to initiate a transition between consecutive primary color image scans. Without intervention, on completion of the current primary color image 138, scanning for the same primary color would continue indefinitely. The interrupt 160 is configured so that after each primary color image 138 is complete, scanning cycles through the primary colors. A complete cycle of three primary color images 138, as represented in FIG. 7, provides the multicolored image 136 perceived by the eye.

Complete frames are formed typically at a frequency of 60 Hz, and the frequency of successive scans is therefore 180 Hz, representing a period of 5.3 ms. The duration of the interrupt 160 is selectable but is typically about 2 ms. This is part of, not in addition to, the 5.3 ms period.

The interrupt 160 is typically a feature of the CPU 142 having the integrated LCD controller 140, an example of which is the StrongARM® SA-1110 Portable Communications Microcontroller. The interrupt 160 is conventionally used to allow functions to be performed between frames 134 which, if they were performed during the formation of a frame might interfere with the control of the frame. Such functions include providing for background timers and mouse control. The interrupt 160 has not heretofore been used in any way in controlling the scanning process.

The interrupt 160 can be hardware-based or software-based. That is, it may be “hard-wired” into the circuitry of the device, or it may be a programmable software feature.

A further novel feature of the present invention is using an R2R network as the d/a converter 144. This consumes significantly less power than conventional d/a converters which have been used heretofore in compact computing devices.

While the invention has been shown and described with particularity, it will be appreciated that various changes and modifications may suggest themselves to one having ordinary skill in the art upon being apprised of the present invention. It is intended to encompass all such changes and modifications as fall within the scope and spirit of the appended claims.

We claim:

1. A method of controlling a display, comprising:
(a) connecting a display controller to a CPU and to the display, the CPU having a progressively organized pixel memory, the controller capable of providing an interrupt; and
(b) scanning the pixel memory using the interrupt to control the scanning, thus providing scanned data to the display in a color field sequential mode.

2. The method of claim 1, including providing that the interrupt is hardware-based.

3. The method of claim 1, including providing that the interrupt is software-based.

4. The method of claim 1, including providing that the CPU is a microprocessor.

5. The method of claim 1, including providing a digital/analog converter between the controller and the display.

6. The method of claim 5, including providing that the digital/analog converter comprises an R2R network.

7. A method of controlling a display, comprising:
(a) connecting a CPU having an integrated display controller to the display, the CPU having a progressively organized pixel memory, the controller capable of providing an interrupt; and
(b) scanning the pixel memory using the interrupt to control the scanning, thus providing scanned data to the display in a sequential mode.

8. A method of controlling a display, the method comprising:
(a) providing a central processing unit;
(b) connecting a display controller to the central processing unit, the controller having an interrupt;
(c) connecting the display to the display controller;
(d) connecting a pixel memory to the display controller;
(e) providing in the pixel memory a plurality of memory locations, each of which contains data corresponding to three primary colors;
(f) sorting the data in the memory according to primary color;
(g) scanning the data to provide an image of a first primary color on the display;
(h) on completion of the first primary color image, using the interrupt to initiate in sequence formation of second and third primary color images, thus forming a multicolored image; and
(i) after formation of the multicolored image, using the interrupt to initiate formation of further images.

9. A method of controlling a display, the method comprising:
(a) providing a central processing unit;
(b) connecting a display controller to the central processing unit, the controller having an interrupt;
(c) connecting the display to the display controller;
(d) connecting a pixel memory to the display controller;
(e) providing in the pixel memory a plurality of memory locations, each of which contains data corresponding to three primary colors;
(f) selecting from the memory locations data corresponding to a first primary color and providing corresponding image signals to the display, thus forming a first primary color image;
(g) on completion of the first primary color image, using the interrupt to initiate in sequence formation of second and third primary color images, thus forming a multicolored image; and
(h) after formation of the multicolored image, using the interrupt to initiate formation of further images.

10. A method of controlling a display, the method comprising:
(a) providing a central processing unit;
(b) providing a display controller within the central processing unit, the display controller having an interrupt;
(c) connecting the display to the display controller;
(d) connecting a pixel memory to the display controller;
(e) providing in the pixel memory a plurality of memory locations, each of which contains data on all three primary colors; and
(f) scanning the memory locations to sequentially form image frames corresponding to each primary color, using the interrupt to initiate scanning for each image frame.

11. A system for controlling a display, comprising:
(a) a display controller connected to the display;
(b) a pixel memory connected to the display controller;
(c) a plurality of memory locations in the pixel memory, each memory location containing data for three primary colors; and
(d) an interrupt in the controller, the interrupt configured to enable the pixel memory to be scanned such that the display sequentially forms images from data corresponding to each of the primary colors.

12. The system of claim 11, including a digital/analog converter between the controller and the display.

13. The system of claim 12, wherein the digital/analog converter comprises an R2R network.
